(19) United States
(12) Patent Application Publication
(10) Pub. No.: US 2001/0042032 A1
(43) Pub. Date: Nov. 15, 2001

(54) System for capturing, processing, tracking and reporting time and expense data

(76) Inventors: Geoffrey K. Crawshaw, Needham, MA (US); William J. O'Farrell, Providence, RI (US); Thomas Brennan, Cambridge, MA (US); Jeffrey Hunt, Boston, MA (US); Michael Monahan, Mystic, CT (US); Boris Boruchovich, Bedford, MA (US); Brett Huff, Cambridge, MA (US)

Correspondence Address: STROOCK & STROOCK & LAVAN LLP, 180 Maiden Lane, New York, NY, 10038, US

(21) Appl. No.: 09/730,247

(22) Filed: Dec. 5, 2000

Related U.S. Application Data
(60) Provisional application No. 60/203,325, filed on May 11, 2000.

(51) Int. Cl. G06F 17/60

(52) U.S. Cl. 705/32

(57) ABSTRACT

A system that accepts and stores raw time and expense data for a plurality of businesses—each business defining a separate account that is accessible and usable by authorized users for the particular business. The inventive system automatically converts the raw time and expense data by considering any client or project-specific billing requirements (e.g., flat-fee, maximum fee, discount, write-offs, etc.) and by applying such specific requirements to the raw time and/or expense data in generating an invoice. The raw data may be referred to as internal data in that it is used only by the business providing a service to their client, and in connection with that business's account by the inventive system. A client will not have access to internal data. The invoice data, on the other hand, may be referred to as external data because it is communicated to the client and also used in connection with that business's account. The inventive system maintains the internal (raw) data, the external (invoiced) data, and other parameters associated with those data in a plurality of relational databases, and coordinates that data between and among a plurality of functionality including time bills, expense reports, time sheets, proposals, and project tracking functionality.

### CROSS-REFERENCE TO RELATED APPLICATION

This application claims priority to Provisional Patent Application Ser. No. 60/203,325 filed on May 11, 2000.

### FIELD OF THE INVENTION

The present invention is directed to a system for capturing, processing, tracking and reporting time and expense data.

### BACKGROUND OF THE INVENTION

In fee-for-service business relationships, both hourly and flat-rate billing are standard practices. It is also common to make accommodations to client invoices in the form of write-offs, discounts, etc. Currently, employees record their time and expenses indicating specific client and client matters to which time and expenses should be charged. That employee time and expense data may then be entered into separate computerized tracking systems for time and expenses that may comprise separate hardware (i.e., computers) and software applications for each of time and expense data, or it may comprise separate software applications on a single computer. Periodic reports may be generated by client and client matter (i.e., project) upon request. Those reports typically provide the raw time and expense data provided by the employee, and do not include any write-offs, discounts, accommodations, etc., that may be made for particular clients. Invoices are generated from the raw time and expense data and also do not include any write-offs, etc. Before an invoice is sent to a client, manual revision is required, with the revised invoice data passed to an accounting department, for example, so that a record of the amount actually invoiced may be maintained.

For many service-based businesses, clients expect and deserve timely and accurate expense and employee time invoicing. As a practical mater, it is often difficult to persuade employees to enter their time and submit their expense reports in a timely manner, especially when incurred while the employee is away from the office. By the time an employee returns to the office, receipts may be lost and, if not previously recorded, time and expense data may be forgotten.

It is thus desirable to provide a system for capturing, processing, tracking and reporting time and expense data that will permit users (i.e., employees) to input their time and expense data using a single system (hardware and software) and that will enable invoices to be generated without the need for manual revision or recording. It is also desirable to provide a system that coordinates time, expense, project, etc., data between and among a plurality of different applications. It is further desirable to provide a system that enables users to input time and expense data at times and locations convenient to the user, and to upload that data to a single system for storage and processing as invoices.

### SUMMARY OF THE INVENTION

The present invention is directed to a system for capturing, processing, tracking and reporting time and expense data. In accordance with the present invention, a system is provided that enables a user (or a plurality of users) to enter various data related to the operation of a business—namely, time, expense, project and proposal data. That data may include, by way of non-limiting example, employee (consultant) time data (weekly, monthly, by project, or other periodic interval), employee (consultant) expense data, proposal data, project data, including project tracking, and is generally referred to herein as internal data. That data is used by the business and inventive system, and is generally not accessible by or made available to a client or customer of the business, or other unauthorized party.

The inventive system further facilitates the generation and reporting of various data to clients, customers, etc. That data may be reported by employee (consultant), project, proposal, etc., and is generally referred to herein as external data. The external data may or may not differ from the internal data. For example, external project tracking data may be the same as internal project tracking data. However, not all internal project tracking data may be made available to a client, customer, etc., but the internal data is not manipulated, modified, or otherwise changed prior to reporting to the client as external data. On the other hand, external time and expense data may differ from internal time and expense data. Foe example, a client may be invoiced at a predetermined rate or fee, which may or may not match the actual incurred fees for the particular project. Regardless of whether the external data is the same as the internal data, the inventive system maintains the internal (raw) data, the external (invoiced) data, and other parameters associated with those data in a plurality of relational databases.

The system generally comprises a server computer that is connected to the Internet and that has a processor operable with general and special purpose software stored on a data storage device of the server. The server may comprise a single computer that, together with the special purpose software, provide the functionality of the present invention. Alternatively, the server may comprise a plurality of interconnected computers which, together with the special purpose software, collectively provide the functionality of the present invention. For the multi-computer embodiment, the plurality of computers (i.e., the server) may include a web server, an application server, and a data server. Either configuration of the server is transparent to the user. The following description of the present invention may, at time, refer to the server, and, at other times, refer to the web, application, and data servers, in describing the interconnection, operation, and functionality of the present invention. Such description is not intended as a limitation of the present invention but, rather, as illustrative, non-limiting examples of two embodiments of the present invention.

Users access the server and the functionality of the present invention via the Internet using a commercially available Internet browser software program (e.g., Microsoft® Explorer, Netscape® Navigator, etc.), which connects the user's computer to the URL (uniform resource location) (IP) address of the server (“the web site”) by submitting a HTTP (hyper text transfer protocol) or HTTPS (hyper text transfer protocol secure) post operation over a TCP/IP network (e.g., the Internet). The browser also renders HTML/Javascript web pages, forms, etc. on the user's computer received from the application server via the web server. The web server provides static objects, encryption, and buffering functionality (for slower Internet connections).

The web server is connected to a network such as, for example, a global network of interconnected computers like the Internet, or a private network, or intranet, or local area network and provides the portal through which users may access the functionality of the present invention. The web server also facilitates bi-directional communication between the server and a user's computer, with simultaneous connection by a plurality of users to the web server being possible in accordance with the present invention. The application server communicates with the web server and stores and runs the various application programs (i.e., part of the special purpose software). The data server communicates with the application server, but not directly with the web server, and stores and indexes both internal and external time and expense data, and account data in one or more relational databases provided on one or a plurality of rapid access data storage units. The data server is the central repository for all data used in connection with the present invention.

The application server receives data from the user's computer and the data server, and may validate or perform other internal operations on that data. For example, when a user logs on, the user's identification and password are compared, by the application server, with that data previously stored on the data server. Based on the results of that comparison, that user's access to the functionality of the inventive system is either approved or denied. After a user has logged on, account data (e.g., clients, projects, etc.) may be retrieved from the data server by the application server and made accessible to the user via the web server. In addition to the more general account-related data (e.g., identifiers for users, clients, projects, etc.) stored on the data server, internal time and expense data, and any external data generated from that internal data, are also stored on the data server. Furthermore, when internal data is converted to external data, the parameters considered by the present invention in performing that conversion are also stored in the data server. Finally, the internal data, external data, and conversion parameters are relationally linked together in one or more databases of the data server. Data stored in the relational database may be downloaded to the user's computer, or used by the server when the user accesses the web site. Data relationships may be established in the database between various data items such as, for example, client identifier, project identifier, expense categories, hours worked, billing rates, service descriptions, payment terms, project budget, user identifiers, and various other information relating to clients and users. By way of non-limiting example, data relationships may be established between: client and project data elements; client-project and time items, expense items, and invoices; “envelopes” and expenses; hours worked, time types, project-client, and service; projects and proposals; expenses and “envelopes” and project-client, service and vendor; users and billing rates; projects and billing rates; services and billing rates; users for approval of time and expense reports; client and payment terms; project and budget amount; service and tax rates; users and ability of user to perform particular actions and/or see particular data, expense items and unit price; and various other combinations of business information.

Once a user has connected to the web site and logged on, a web page is displayed on the user's computer by the browser. At the web page, the user may make various selections depending upon the particular functionality desired (e.g., enter time, expenses, administer account, generate invoice, etc.). Each selection (i.e., each mouse click) is processed by the web server and passed on to the application server which invokes or executes one or more software programs that, individually or collectively provide the functionality required by the user's selection.

The general purpose software on the server provides the functionality that enables general operation of the server such as, for example, connection to and communication with the Internet, data storage and retrieval from the data storage device, general operational and administrative functions, etc. The special purpose software provides the functionality that enables the server (i.e., the web server, application server, and data server) to communicate and interact in accordance with the present invention. For example, the special purpose software may comprise a plurality of web-native application programs for creating and administering accounts, permitting users to enter time and expense data, and storing and retrieving any such data, and for generating invoices by converting entered time and expense data, and for automatically or manually sending an invoice to a client, creating proposals and projects, and other functionality, as described in more detail below.

As used herein when referring to computer software, the term web-native refers to functionality (e.g., executable files, applications, Javascript, applets, etc.) accessible by a user at a web site or via the Internet, with no functionality provided locally at the user's computer.

The web-native special purpose software, together with the server and a server processor (i.e., web server/processor, application server/processor and data server/processor) that is operable with the general and special purpose software, provide a system for capturing, processing, tracking and reporting internal time and expense data, and for invoicing clients using external time and expense data that is derived from the internal time and expense data. As used herein, the term “internal”, when used to refer to time and expense data, refers to raw data entered by a user that reflects the actual time spent and expenses incurred in providing a particular service or in completing a particular project, without consideration of any write-offs, discounts, or other accommodations sometimes provided to clients. As used herein, the term “external”, when used to refer to time and expense data, refers to time and expense data derived from internal time and expense data; “derived from” generally referring herein to manipulation, modification, etc., of the internal data by the server and special purpose software to produce external data. For example, consider a project that was quoted as a flat fee of $5000 for time and with expenses capped at $1000. If an employee enters 30 hours in completing the project, at a rate of $250 per hour, and incurs $1500 in expenses for that project, the internal time data is 30 hours and $7500, and the internal expense data is $1500. Before invoicing a client, the internal time data is written down to 20 hours and $5000, and the internal expense data is written down to $1000, to provide the external time and expense data, respectively. The present invention maintains both the internal and external data in the database on the data server and relationally links that data. The internal data may be used for various administrative functions including, but not limited to, tracking employee efficiency, project profitability, and expenses. The external data is used by the present invention to generate a report, invoice, etc., and to bill a client.

The special purpose software may also include an off-line application program that users download to their computer and that is compatible with various computer operating systems, including personal digital assistant operating systems, personal computer operating systems and wireless operating systems. The off-line application program enables user to capture time and expense data via a user interface that mimics the user interface provided when the user is connected to the web site. The off-line application program may be downloaded from the web site, and installed and run on the user's computer, independent of the server. Account data may be downloaded to the user's computer from the relational database on the data server each time the user establishes a connection to the web site. A user may enter time and expense data that is stored in a temporary database on the user's computer, and uploaded to the data server when initiated by the user. All data entered by the user is deleted from the user's computer by the special purpose software when the user elects to upload data to the server.

The server also includes an application programmer interface (API) that specifies the protocol, format, etc., for time, expense and invoicing data packets imported into the server from another software application (i.e., a software application not provided on the server nor included as part of the special purpose software). The API uses extendible markup language (“XML”) as a data protocol to communicate between the user and the API. In the API, a unique set of XML commands and data structures is defined to facilitate the transfer of information. The API enables seamless and real-time exchange of time, expense and invoicing data between the data server (database) and other web-based or platform specific software applications. Users may access the API via the web server and application server, and data communicated to the server from another web-based or platform specific application program is via a socket connection between a remote computer and the web server. Such data communication may be bi-directional and typically does not invoke the special purpose software to effect data transfer. Rather, the other application program transfers data to or receives data from the data server.

The invention accordingly comprises the features of construction, combination of elements, and arrangement of parts which will be exemplified in the disclosure herein, and the scope of the invention will be indicated in the claims.

### BRIEF DESCRIPTION OF THE DRAWINGS

In the drawing figures, which are not to scale, and which are merely illustrative, and wherein like reference characters denote similar elements throughout the several views:

FIGS. 1A and 1B are schematic representations of two embodiments of a system for capturing, processing, tracking and reporting data comprising a server having a processor and special purpose software and configured in accordance with the present invention;

FIG. 2 depicts the architectural configuration of the functionality provided by the server and special purpose software of the present invention;

FIG. 3A depicts an exemplary time bills web page accessible via the web site;

FIG. 3B is a diagrammatic view of the functionality provided via the time bills web page depicted in FIG. 3A;

FIG. 4A depicts an exemplary expense reports web page accessible via the web site;

FIG. 4B is a diagrammatic view of the functionality provided via the expense reports web page depicted in FIG. 4A;

FIG. 5A depicts an exemplary time sheets web page accessible via the web site;

FIG. 5B is a diagrammatic view of the functionality provided via the time sheets web page depicted in FIG. 5A;

FIG. 6A depicts an exemplary proposals web page accessible via the web site;

FIG. 6B is a diagrammatic view of the functionality provided via the proposals web page depicted in FIG. 6A,

FIGS. 7A-7C depict exemplary project tracking web pages accessible via the web site; and

FIG. 7D is a diagrammatic view of the functionality provided via the project tracking web pages depicted in FIGS. 7A-7C.

### DETAILED DESCRIPTION OF THE PRESENTLY PREFERRED EMBODIMENTS

The present invention is directed to a system for capturing, processing, tracking and reporting time and expense data. In accordance with the present invention, a system is provided that enables a user (or a plurality of users) to enter various data related to the operation of a business—namely, time, expense, project and proposal data. That data may include, by way of non-limiting example, employee (consultant) time data (weekly, monthly, by project, or other periodic interval), employee (consultant) expense data, proposal data, project data, including project tracking, and is generally referred to herein as internal data. That data is used by the business and inventive system, and is generally not accessible by or made available to a client or customer of the business, or other unauthorized party.

The inventive system further facilitates the generation and reporting of various data to clients, customers, etc. That data may be reported by employee (consultant), project, proposal, etc., and is generally referred to herein as external data. The external data may or may not differ from the internal data. For example, external project tracking data may be the same as internal project tracking data. However, not all internal project tracking data may be made available to a client, customer, etc., but the internal data is not manipulated, modified, or otherwise changed prior to reporting to the client as external data. On the other hand, external time and expense data may differ from internal time and expense data. Foe example, a client may be invoiced at a predetermined rate or fee, which may or may not match the actual incurred fees for the particular project. Regardless of whether the external data is the same as the internal data, the inventive system maintains the internal (raw) data, the external (invoiced) data, and other parameters associated with those data in a plurality of relational databases.

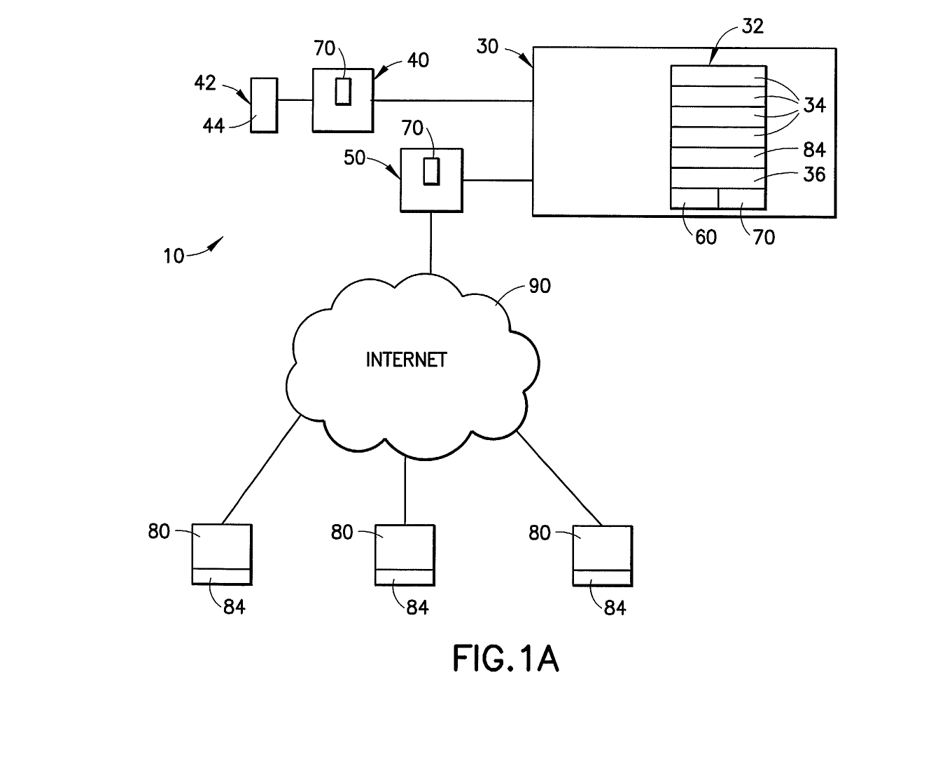

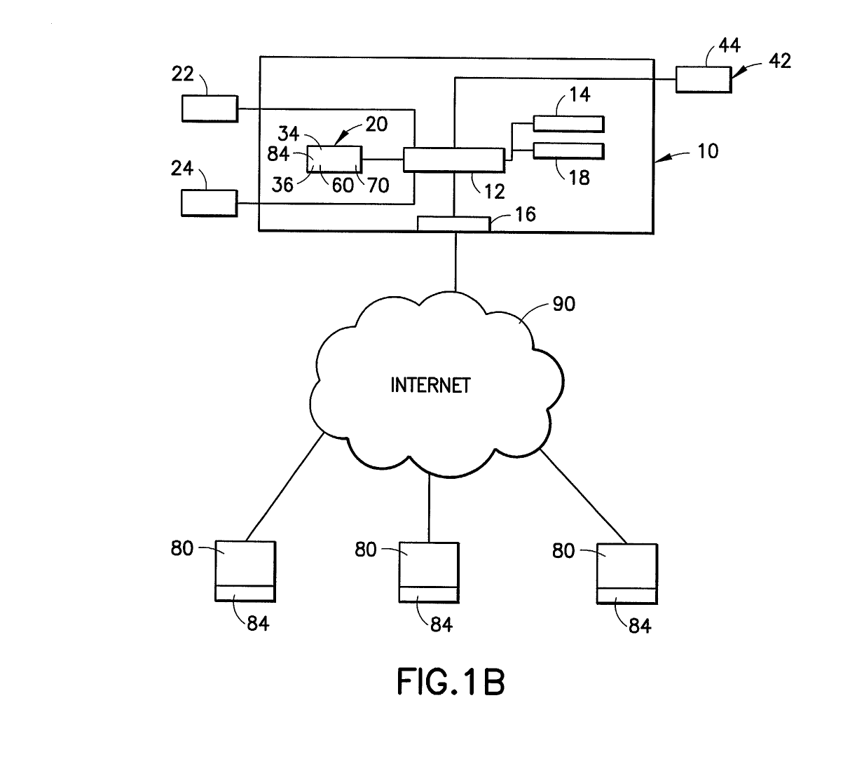

Referring next to the drawings, FIGS. 1A and 1B are schematic representations of two embodiments of a system constructed in accordance with the present invention for capturing, processing, tracking and reporting data and comprising a server 10 having special and general purpose software installed thereon. The server 10 is connected to a network 90, preferably the Internet, although the server 10 may be connected to any network, whether land-based, cellular, satellite, etc., that facilitates bi-directional communication of data between a plurality of computing devices; the specific network to which the server 10 connects not being essential to the present invention. For ease of discussion, and not for limitation or definition of the present invention, the network 90 will be referred to herein as the Internet.

The server 10 includes a web server 50 connected to the Internet 90, and to an application server 30, which is connected to a data server 40. The server 10 may comprise a single computer (see, e.g., FIG. 1B), such as, for example, a computer having a processor 12 operable at a clock speed of at least 700 MHz, and having 1 Gigabyte or more of random-access memory (RAM) 14, read-only memory (ROM) 18, a 10 Gigabyte hard-disk unit (HDU) 20, and a communications interface 16 (e.g., ROM BIOS (basic input-output system, modem, etc.). An external data storage device, such as a RAID storage device 42, is connected to the server 10 and has a plurality of databases defined thereon and in which the various data used by and in connection with the present invention may be stored. In the configuration depicted in FIG. 1B, the functionality of the web server 50, application server 30, and data server 40 are provided on a single computer via general and special purpose software 70, 60 stored on the HDU 20.

Alternatively, the server 10 may comprise a plurality of interconnected computers, as depicted in FIG. 1A, each having hardware components essentially as described above with respect to FIG. 1B. In the configuration depicted in FIG. 1A, the server 10 comprises separate computers for the web server 50, application server 30, and data server 40; with the external data storage device 42 being connected to the data server 40. The web server 50 is connected to the Internet 90 and to the application server 30, which is connected to the data server 40, i.e., the data server 40 communicates with the web server 50 only through the application server 30. The special purpose software 60 is preferably provided on the application server 30, and general purpose software 70 being provided on each of the servers.

With continued reference to FIGS. 1A and 1B, a plurality of user computers 80 may simultaneously establish a connection to the server 10 via the Internet 90 and access the functionality of the present invention. The computers 80 may comprise any type of stationary or mobile computing device, including by way of non-limiting example, a personal computer (desktop or laptop), a personal digital assistant (PDA), a cellular telephone, or any other portable computing device having the hardware and software components necessary to provide the functionality required by the present invention, and as discussed in more detail herein. Connection between the user computer 80 and the server 10 via the Internet 90 may be by via any land-based, cellular, satellite, or other bi-directional communication system or means, that detail not being an essential aspect of the present invention. The user computers 80 may have an offline application program 84 that comprises part of the special purpose software and that is downloadable from the application server 30, as discussed in more detail below.

With continued reference to FIGS. 1A and 1B, the configuration and functionality of the hardware and software components of the server 10 will now be discussed. In an embodiment of the present invention, the web server 50 may comprise an Apache proxy server running mod_ssl, mod_proxy, and implementing the latest communication protocols, including HTTP/1.1 (RFC2616), and various other known or hereafter developed communication protocols. The web server 50 may run on various operating systems including Windows NT/9x, Netware 5.x, OS/2, and most versions of Unix, as well as other operating systems now known or hereafter developed.

The web server 50 is defined by an IP address which also serves to define a predetermined URL (“the web site”) at which a user may access the functionality of the present invention. The web server 50 also facilitates bi-directional communication between users and the application server 30 and data server 40. A user may connect to the web site (and thereby access the functionality of the present invention) using a browser and a computer 80 to establish a socket connection to the web server 50 using the server's IP address. Once the user's computer 80 is connected to the web server 50 in that manner, the application server 30 passes hypertext mark-up language (HTML) and/or Javascript code to the user's browser through the web server 50 to facilitate the display of desired web pages at the user's computer 80. As the user navigates the web site, different web pages may be displayed on the user's computer 80.

The web server 50 provides the portal through which users may access the server 10 via the Internet 90 and facilitates bi-directional communication between the server 10 and a user's computer 80 (simultaneous connection by a plurality of users to the web server is possible in accordance with the present invention). The application server 30 communicates with the web server 50 and stores and runs the various web-native application programs that comprise the special and general purpose software 60, 70. The data server 40 communicates with the application server 30, but not directly with the web server 50, and stores and indexes both internal and external time and expense data, and account data in one or more relational databases 44 provided on one or a plurality of rapid access data storage devices 42 (e.g., RAID disk drives).

Users access the server 10 and the functionality of the present invention via the Internet 90 using a commercially available Internet browser software program (e.g., Microsoft® Explorer, Netscape® Navigator, etc.), which connects the user's computer 80 to the web site by submitting a HTTP or HTTPS post operation over the Internet 90. The browser also renders HTML/Javascript web pages, forms, etc. on the user's computer 80 received from the application server 30 via the web server 50. The web server 50 provides static objects, encryption, and buffering functionality (for slower Internet connections).

Once a user has connected to the web site and logged on, a web page is displayed on the user's computer 80 by the browser. At the web page, the user may make various selections depending upon the particular functionality desired (e.g., enter time, expenses, administer account, generate invoice, track project, create expense report, create proposal, etc.). Each selection (i.e., each mouse click) is processed by the web server 50 and passed on to the application server 30 which invokes or executes all or part of one or more software programs of the special and general purpose software 60, 70 and that, individually or collectively, provide the functionality required by the user's selection.

The data server 40 is the central repository for all data used in connection with the present invention. The application server 30 typically receives data from the data server 40, and may validate or perform other internal operations on that data, or it may make that data available to the user. For example, when a user logs on, the user identification and password data are received by the web server 50, passed thereby to the application server 30, and compared by the application server 30 with data for that user previously stored on the data server 40. Based on the results of that comparison, that user's access to the server 10 and the functionality of the present invention is either approved or denied. After a user has logged on, account data (e.g., clients, projects, etc.) may be retrieved from the data server 40 by the application server 30 and made accessible to the user. In addition to the more general account-related data stored on the data server 40 (e.g., identifiers for users, clients, projects, etc.), internal time and expense data, and any external data generated from that internal data, are also stored on the data server 40. Furthermore, when internal data is converted to external data, the parameters considered by the present invention in performing that conversion are also stored in the data server 40 and relationally linked to the internal and external data in one or more databases 44 of the data server 40. Data stored in the relational database 44 may be downloaded to the user's computer 80 for use by the off-line program 84, or used by the server 10 when the user accesses the web site. Data relationships may be established in the database 44 between various business data items such as, for example, client identifier, project identifier, expense categories, hours worked, billing rates, service descriptions, payment terms, project budget, user identifiers, and various other information relating to clients and users.

The general purpose software 70 provides the functionality that enables general operation of the server 10 such as, for example, connection to and communication with the Internet 90, data storage and retrieval from the data storage device 42, general operational and administrative functions, etc. The special purpose software 60 provides the functionality that enables the server 10 (i.e., the web server 50, application server 30, and data server 40) to communicate and interact in accordance with the present invention. For example, the special purpose software 60 may comprise one or a plurality of web-native application programs for creating and administering accounts, permitting users to enter time and expense data, and storing and retrieving any such data, and for generating invoices by converting entered time and expense data and automatically or manually sending an invoice to a client creating proposals and projects, and other functionality, as described in more detail below.

As used herein when referring to computer software, the term web-native refers to functionality (e.g., executable files, applications, Javascript, applets, etc.) accessible by a user at a web site or via the Internet, with no functionality provided locally at the user's computer.

The web-native special purpose software, together with the server and a server processor (i.e., web server/processor, application server/processor and data server/processor) that is operable with the general and special purpose software, provide a system for capturing, processing, tracking and reporting internal time and expense data, and for reporting time and expense date (e.g., by invoicing clients) using external time and expense data that is derived from the internal time and expense data. As used herein, the term “internal”, when used to refer to time and expense data, refers to raw data entered by a user that reflects the actual time spent and expenses incurred in providing a particular service or in completing a particular project, without consideration of any write-offs, discounts, or other accommodations sometimes provided to clients. As used herein, the term “external”, when used to refer to time and expense data, refers to time and expense data derived from internal time and expense data; “derived from” generally referring herein to manipulation, modification, etc. of the internal data by the server and special purpose software to produce external data.

With continued reference to FIGS. 1A and 1B, the functionality provided by the server 10 and the special purpose software 60 of the present invention will now be discussed in greater detail. Generally speaking, the web server 50 receives data from a user (entered via the user's web browser), encrypts the data if necessary, and passes the encrypted data to the application server 30. The application server 30 stores and runs the various application programs which comprise the special purpose software 60, and which individually and collectively parse, validate, and carry-out certain processes on data received from a user and on data resident on the data server 40. For example, the application server 30 compares identification and password data entered by a user during the sign on or log on process with that user's data previously stored on the data server 40. An approval or denial is communicated by the application server 30 to the user's computer 80 based on the results of that comparison. The application server 30 also generates external time and expense data used when invoicing client by performing certain conversions, calculation, manipulations, etc., on internal data stored on the data server 40 to produce external data. The application server 30 receives time and expense data input from a user (i.e., internal data), which is relationally linked to user-selected business data items previously defined for that user's account. Business data items may include client identifier, project identifier, expense categories, hours worked, billing rates, service descriptions, payment terms, project budget, user identifier. The application server 30 passes the user-entered internal time and expense data to the data server 40 for storage in the database 44 on the data storage device 42. The data server 40 passes business data items (e.g., including, but not limited to, client identifier, project name/description, service types, billing rates, payment terms, project and budget amount, tax rates, etc.), and internal time and expense data to the application server 30, which generates formatted HTML and Javascript using the time and expense data and which is then passed to the web server 50 for communication to and display on a user's computer 80 when the user accesses the server 10.

The application server 30 also generates external time and expense data used when invoicing a client by performing certain conversions, calculations, manipulations, etc., on internal data stored on the data server 40 to produce external data.

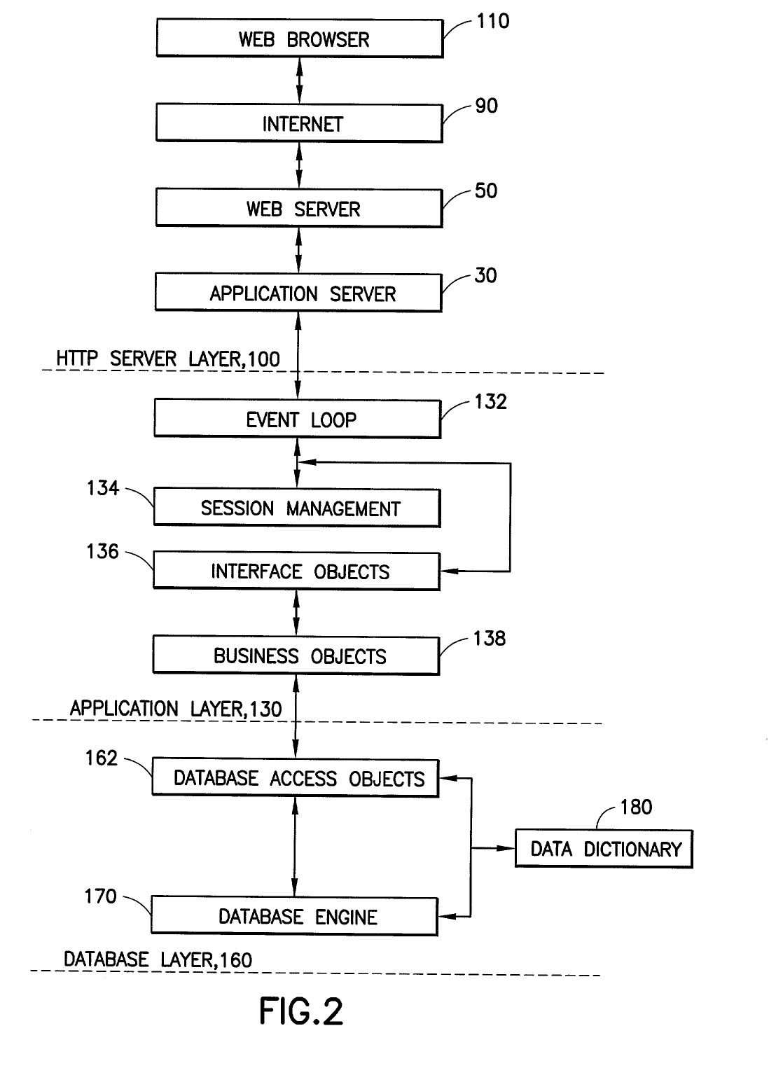

Referring next to FIG. 2, an embodiment of the functionality provided by the special purpose software and the architectural configuration of the server 10 will now be discussed. As mentioned previously herein, reference to the server 10 and its functionality also includes the web server 50, application server 30, and data server 40. Thus, the architectural configuration depicted in FIG. 2 is representative of both the single-computer and multi-computer embodiments of the server 10. The server 10 may be architecturally divided into a HTTP (hypertext transfer (transport) protocol) or HTTPS (secure) server layer 100, an application layer 130, and a database layer 160. In the HTTP server layer 100, graphical interfaces (e.g., web pages, forms, etc.) are rendered on the user's computer 80 by the user's web browser 110, which interprets HTML, Javascript, etc., code (“code”) received from the server 10 to render the graphical interface and provide any functionality defined by the code. Thus, when a user selects a hypertext link on a web page by clicking his/her mouse on that link, that selection is communicated by the user's browser 110 via the Internet 90 to the web server 50, which processes the selection and passes the information on to the application server 30. In response, the application server 30 dynamically generates a HTML/Javascript web page and communicates that data to the user's browser 110 via the web server 50 and Internet 90.

In the HTTP server layer 100, the web server 50 communicates with the application server 30, which runs the special purpose software which parses, validates, and performs certain processes (i.e., calculations, data manipulations, data modifications, etc.) on user-entered data (i.e., internal data) to produce external data. In the application layer 130, the event loop 132 and session management 134 elements carry out that functionality. More specifically, the event loop 132 utilizes callbacks in which a calling object passes a set of defined actions to a called object. For example, when a user first logs on to the server 10, the user's identification and password data are communicated to the application server 30 for processing by the event loop 132. The event loop 132 calls a user validation object and passes the identification and password data to that called validation object. The called validation object validates or rejects the identification and/or password data and passes the results to the interface object 136, which generates appropriate HTML and Javascript code that is communicated to the user's browser 100 and displayed on the user's computer 80. An interface object 136 may encapsulate the functionality of forms, lists, navigation tabs, fonts, colors, etc., so as to provide a consistent graphical user interface at the user's computer 80. Business objects 170, which encapsulate any predefined business rules (that may be globally specified or specified per account) and relationships between and among clients, projects, etc., may also be included in an interface object 136.

The event loop 132 also communicates with session management 134, which is accomplished using embedded URL identifiers. Session management 134 may be implemented as a file, database interface (DBI), or lightweight directory access protocol (LDAP) storage, enabling dynamic load allocation by the server 10 to multiple servers, i.e., to any of the web server 50, application server 30, or data server 40.

In the database layer 160, data from the application layer 130 (i.e., from the application server 30) is passed to the data server 40 as database objects 162, which provide a high level hash-based interface to data on the data server storage device 42, and which facilitate business object 138 manipulation of that data. A database engine 170 (e.g., MYSQL) stores and indexes various data in at least one database 44 or alternatively, in a plurality of databases; each account (i.e., each company) having its own database in that case. An account's database 44 may be provided on a single storage device 42 (i.e., on a single data server 40), or distributed across multiple storage devices 42 and/or data servers 40. That configuration permits scaling of a data set without compromising the speed of individual databases 44. The database engine 170 also passes data from the data server 40 to the application server 30; that passed data being internal and/or external data. A XML-based data dictionary 180 is provided in the database layer 160 which programmatically adjusts the data structure across multiple databases and provides database documentation.

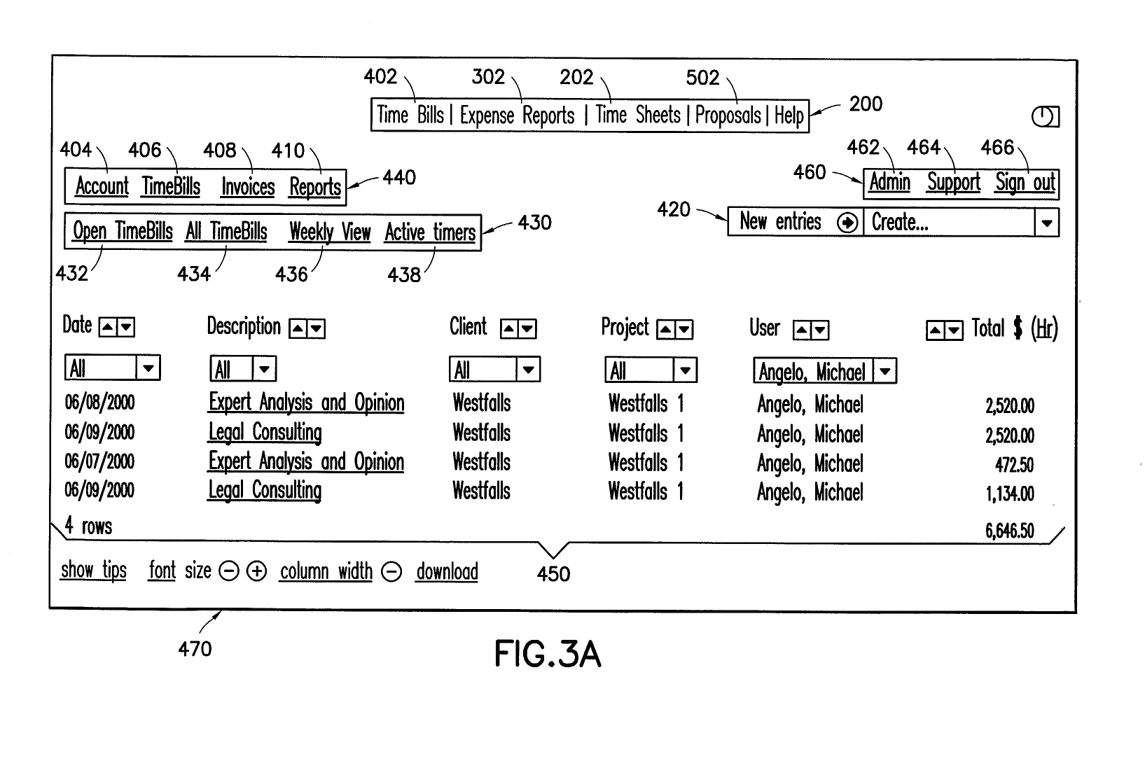

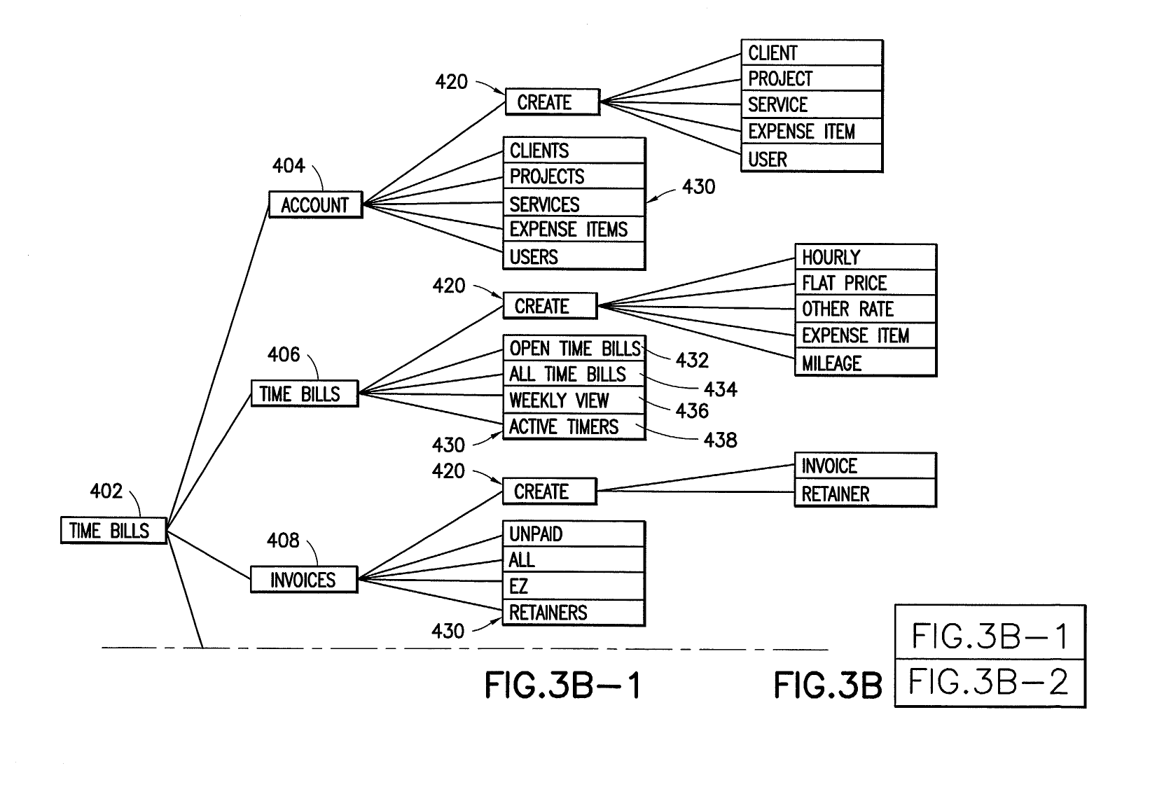

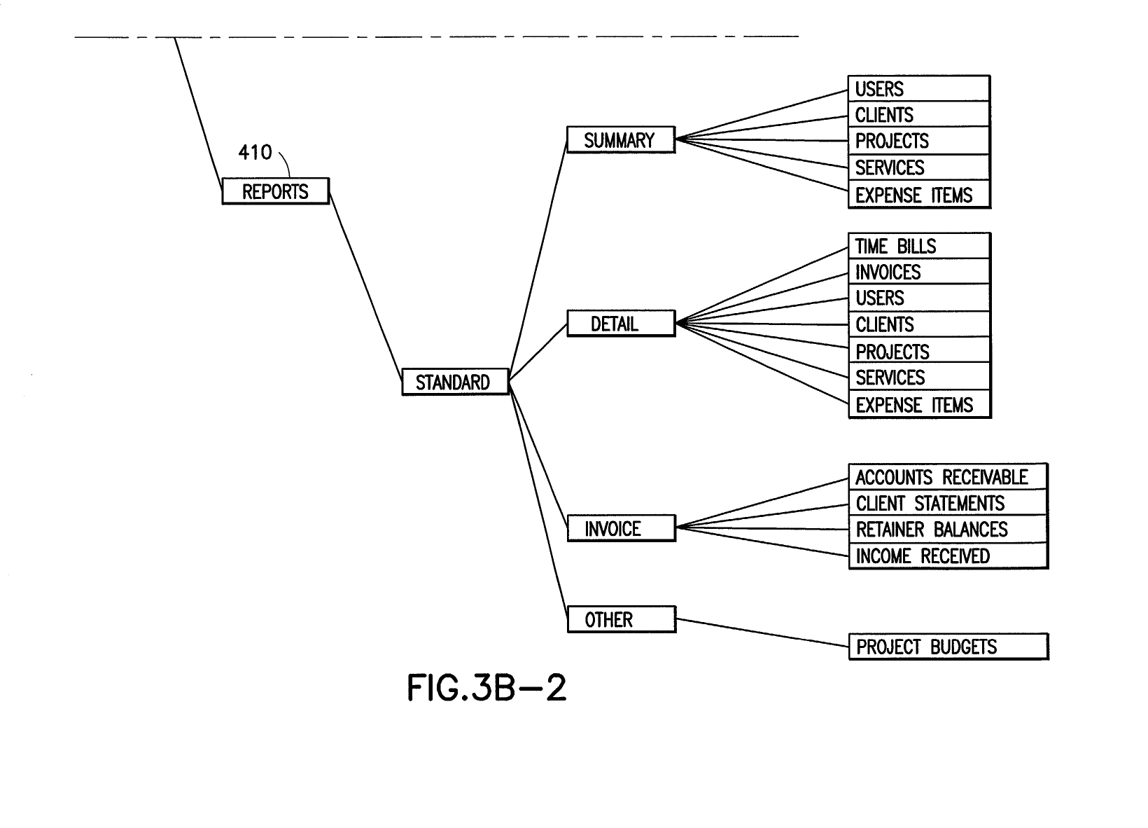

Referring next to FIGS. 3-7, the functionality provided by the special purpose software 60 and server 10 in accordance with the present invention, including, but not limited to time bills, expense reports, time sheets, proposals, and project tracking application program functionality, will now be described in more detail.

In operation, a user accesses the web site, as described above, and the web page for the web site is displayed on the user's computer 80. Various information is provided to the user via the web page, including the ability of the user to log on by selecting a “sign in option” which causes a sign in web page to be displayed on the user's computer 80. At the sign in web page, the user may enter company identification, user identification and password data which is communicated to the application server 30 via the web server 50 when the user manually elects to sign in. The application server 30 validates the company identification, user identification, and password data by comparing that data with data stored on the data storage device 42 of the data server 40 for the user's account. If the user-enter data is validated by the application server 30, the application server communicates a new web page to the user's computer 80. Thereafter, each user will have access only to specific account data and may enter and/or modify that data based upon each user's predefined authorization level. For example, three levels of user authorization may be defined: administrator, power user and user. A user's authorization level is set when the user is first defined (i.e., a new user) by a system administrator, for example. Administrators (there may be more than one administrator defined for each account) have full access to all the features and functionality provided by the various application programs and by the special purpose software 60, with the exception of being able to create or modify data for another user. Administrators may create new administrators, power users, and users, customize forms (e.g., invoices), assign and/or change users' password and identification data, access, add, or change user and company information forms, and perform various other administrative functions with respect to the server 10 and special purpose software 60. Power users have access to many of the same features and functionality as administrators, save for the ability to create users, invoices, or other client-interface documents. Users may create, edit, or delete only their own data, and can view data of other users provided an administrator has linked the two users (i.e., by assigning user B to user A). The term “user” is generally used herein to refer to any type of user. Where a specific user type is intended, appropriate specific reference shall be made to that specific user type.

After a users logs on, the application server 30 communicates a web page 470 (see, e.g., FIG. 3A) to the user's computer 80 for display by the browser. From that web page 470, the user may access all the functionality of the present invention. A user may functionally navigate the web site by selecting a link from a high-level navigational link 200 which includes time bills 402, expense reports 302, time sheets 402, proposals 502, project tracking 702, and help 602 navigation links, or the user may select an administrative link 460 which includes administrative 462, support 464, and sign out 466 links. The time bills 402, expense reports 302, time sheets 202, proposals 502, and project tracking 702 navigational links provide user access to the high-level functionality provided by the server 10 and special purpose software 60, namely the time bills, expense reports, time sheets, proposals, and project tracking features of the special purpose software 60. User-selection of any of those links causes the application server 30 to invoke one or more application programs of the special purpose software 60, communicate with the data server 40 if data retrieval or storage are required, and communicate the appropriate HTML, Javascript, account, etc. data to the user's computer 80. User-selection of any of the high-level navigational links 202, 302, 402, 502, 702 also provides user access to additional functionality provided by each of the time bills, expense reports, time sheets, proposals, and project tracking application programs that comprise the special purpose software 60. Those functionality and selections vary depending upon which high-level navigational link 200 is selected. The additional functionality may include access to application navigation links 440 (also 240, 340, 540 and 740), which provides navigation within each one of the time bills, expense reports, time sheets, proposals, and project tracking application programs, data entry links 420 (also 220, 320, 520, and 720), which permits a properly authorized user to enter new data, and data viewing and editing links 430 (also 230, 330, 530 and 730), which permits a properly authorized user to view and edit data. The administrative links 460 provide user access to administrative functionality such as password changes (all users), company information, account, encryption, terminology, and layout changes (administrative only). The same administrative links 460 are provided on each of the time bills, expense reports, time sheets, proposals, and project tracking web pages, and thus will not be discussed for each of those web pages.

With continued reference to FIGS. 3A and 3B, the time bills functionality and web page will now be discussed in greater detail. The time bills functionality enables a user, typically a manager or supervisor, to access the web site and navigate to a user interface form through which the user can either view external (i.e., billable) time and expense items transmitted from the time sheets and expense reports application programs, or create new time and expense items directly in the application (i.e., internal time and expense data). The user may then view and select specific time and expense items for inclusion on an invoice (using a check box method, for example). The user creates an invoice and may preview the invoice in HTML or in a PDF format.

Invoice data is stored in two relational tables in an account's database 44; a header and a footer table (which may also be respectively referred to as invoice and slip). To create an invoice, the special purpose software 60 issues an SQL request to the database 44 to retrieve the header record for the desired invoice. The header record contains information such as the invoice number, date, customer etc. After the header record is retrieved, the special purpose software 60 send a series of SQL requests to the footer table to retrieve the individual line items of invoice data. The returned data is held in a Perl data structure like hashes and lists in random access memory.

The special purpose software 60 then determines the invoice format based upon the customer profile previously created (by a system administrator or other suitably authorized user) and stored in the database 44 and proceeds to iterate through the data structures to generate an invoice based upon the previously stored invoice format and data retrieved from the database 44. As the special purpose software 60 iterates through the data structures, it takes the data elements and encapsulates them in the appropriate HTML escape characters and sends the resultant output to the web server 50 to be delivered to the user's browser. The browser receives the data and renders it based upon the HTML tags and formatting, thus displaying the invoice in the user's browser.

After reviewing the invoice, the user may select an invoice delivery method from a plurality of available delivery methods. For example, if the user selects email delivery, the time bills application program automatically sends an email to the client with an embedded link to the invoice at the web site. The client may open the email and view and print the invoice via a browser by clicking on the embedded link. The user can alternatively send the invoice via U.S. Mail, or other more traditional delivery methods. When this delivery option is selected by the user, a hardcopy of the invoice is printed at a predetermined computer, and mailed to the client. The user can also enter any client payments received for invoice payment via the time bills functionality.

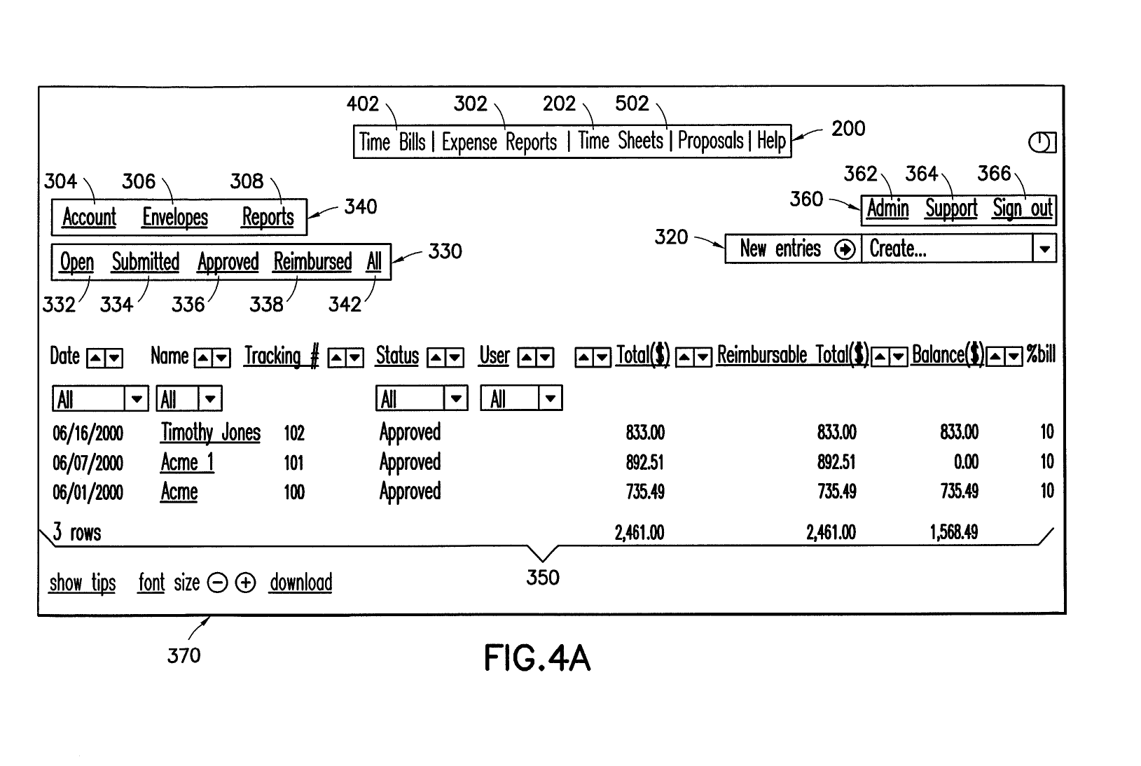

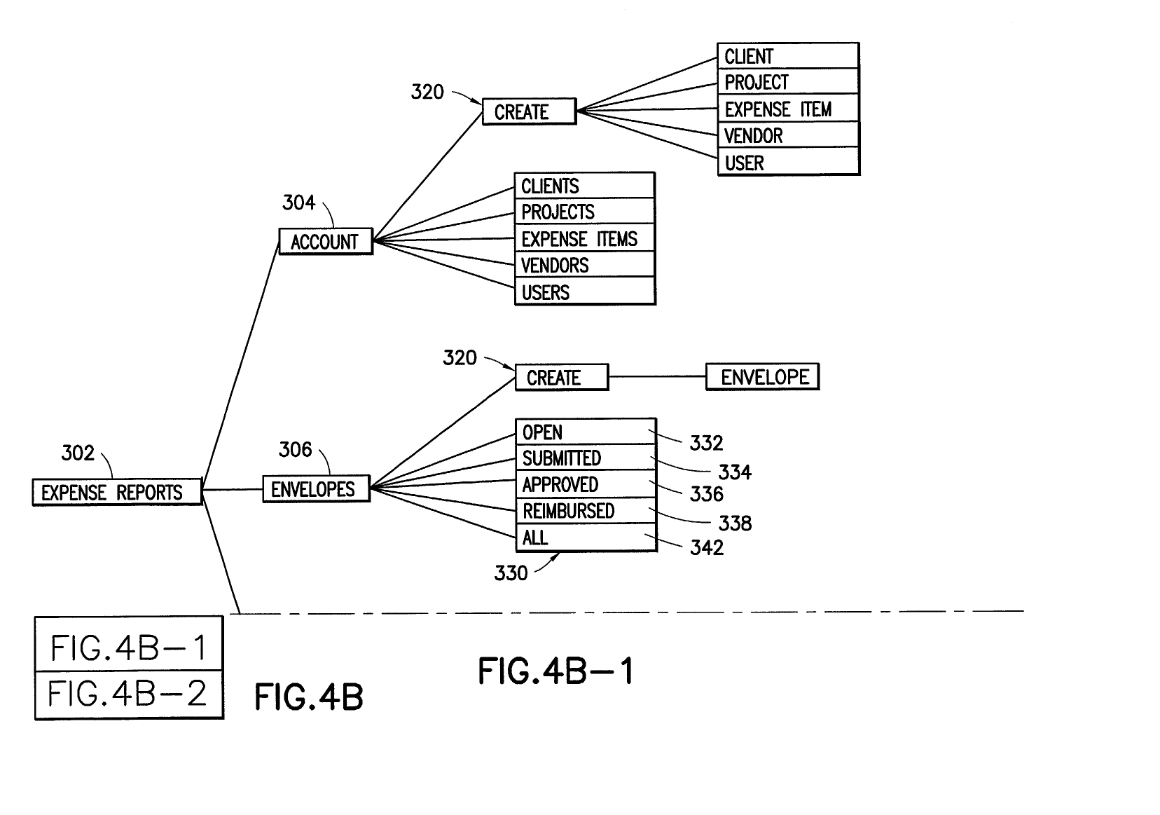

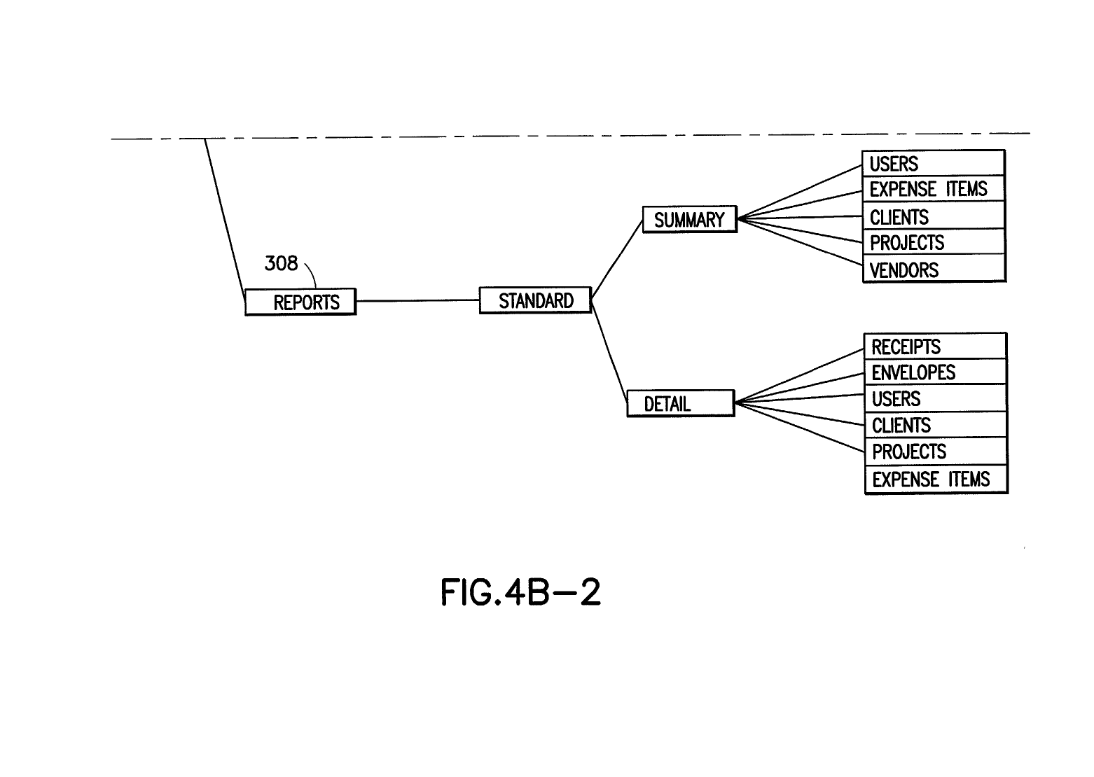

For the time bills web page 470 depicted in FIG. 3A, a user has selected time bills 406 (from the application navigation links 440) and open time bills 432 (from the data viewing and editing links 430), and the data 450 depicted in that figure represent that user's account data for all open time bills (e.g., date, description, client name, project name, user identification, and total dollars or hours). The diagrammatic view of FIG. 3B depicts all the selections available to a user via the time bills web page 470. However, only the web page for a time bills 406 and open time bills 432 selection is depicted in FIG. 3A. It will be obvious to persons skilled in the art and from the disclosure provided herein that other web page representations will be provided when a user makes other available selections of the time bills functionality. That will also hold true for the expense reports, time sheets, proposals, and project tracking functionality, and for their respective web pages (see, e.g., FIGS. 4A, 5A, 6A, and 7A). Thus, the functionality provided by the application server 30 and special purpose software 60 will facilitate the selections for every web page provided in accordance with the embodiments of the present invention, as generally depicted by the exemplary representations of FIGS. 3B, 4B, 5B, 6B, and 7B.

With continued reference to FIG. 3A, and with additional reference to FIG. 3B, the application navigation links 440 for the time bills web page 470 enable a user to select account 404, time bills 406, invoices 408, or reports 410 functionality. The account link 404 enables a user to create, view, sort, and edit client, project, service, expense item, or user data, as depicted in FIG. 3A. The time bills link 406 enables a user to create hourly, flat price, other rate, expense item, or mileage time bills, or to view open time bills, all time bills, time bills by week, or active timers. The invoices link 408 enables a user to create new invoices or retainers, or view unpaid, all, or EZ invoices, or retainers, sorted by user, client, project, etc. If EZ invoices is selected, the application server 30 and special purpose software 60 automatically generate and print an invoice based on user-selected criteria (e.g., client, project, etc.). That printed invoice may be manually mailed. The reports link 410 enables a user to create standard summary, detail, invoice, or other reports. Summary reports may be created based on users, clients, projects, services, or expense items. Detail reports may be created for time bills, invoices, users, clients, projects, services, or expense items. Invoice reports may be created for accounts receivable, client statements, retainer balances, or income received. Other reports may be created for project budgets.

The present invention also maintains, in at least one relational database, all data entered, changed, reported, etc., in connection with each business, with each business' clients, employees, consultants, expenses, projects, proposals, etc., and coordinates that various data between and among the functionality of the present invention (i.e., time bills, expense reports, time sheets, proposals, and project tracking) to provide a comprehensive and coordinated

When a user selects invoices link 408, and specifically, to create a new invoice, the application server 30 and special purpose software utilize various user-selected criteria to convert internal data to external data. For example, consider a project that has been previously defined as a flat price project. Users may enter their time and expenses (using time sheets and expense reports functionality) incurred in connection with that project; with those time and expenses possibly exceeding the flat price for that project. When an invoice is created, the application server 30 and special purpose software 60 create external data for use on that invoice by considering the internal data and previously defined parameters (i.e., flat price) for that project. The internal data, previously defined parameters, and external data are relationally stored in by the data server 40 in the database 44, and an invoice is created using only the external data.

Referring next to FIGS. 4A and 4B, the expense reports functionality provided by the server 10 and special purpose software 60 in accordance with the present invention will now be discussed. The expense reports functionality enables a user to create an electronic “envelope” for a group of expenses and automatically prompts the user to create individual invoice records associated with the envelop, including associating the expenses incurred with a specific client, a specific project, and a specific service. When the user has finished entering expenses incurred for a specific client, a specific project, and a specific service, the envelop may be automatically submitted to a manager for approval, as described above with regard to the time sheets functionality. Expenses may also be selected for porting to time bills (described in more detail below).

For the expense reports web page 370 depicted in FIG. 4A, a user has selected envelopes 306 (from the application navigation links 340) and all 342 (from the data viewing and editing links 330), and the data 350 depicted in that figure represent that user's account data for all 19 envelopes (e.g., date, client name, tracking number and status, user identification, total dollars, reimbursable total dollars, outstanding balance, and percent billed). The diagrammatic view of FIG. 4B depicts all the selections available to a user via the expense reports web page 370. The envelopes link 306 enables a user to create new envelopes, or to view and sort open, submitted, approved, reimbursed, or all envelopes. Expense data may be entered in an envelope including the date, amount, and type of expense incurred. Individual receipts may be created to track individual expenses. Each receipt is then associated with a particular envelope. Envelopes and receipts created using the off-line application program 84 may be uploaded to the data server 40 when the user connects to the server 10. The reports link 306 enables a user to generate various reports including summary reports for users, expense items, clients, projects and vendors, and detail reports for receipts, envelopes, users, clients, projects, and expense items. The account link 304 available via the expense reports web page 370 enables a user to create, view, sort, and edit client, project, expense item, vendor, or user data. The reports link 308 enables a user to create summary reports of users, expense items, clients, projects or vendors, or to create detail reports of receipts, envelopes, users, clients, projects, or expense items.

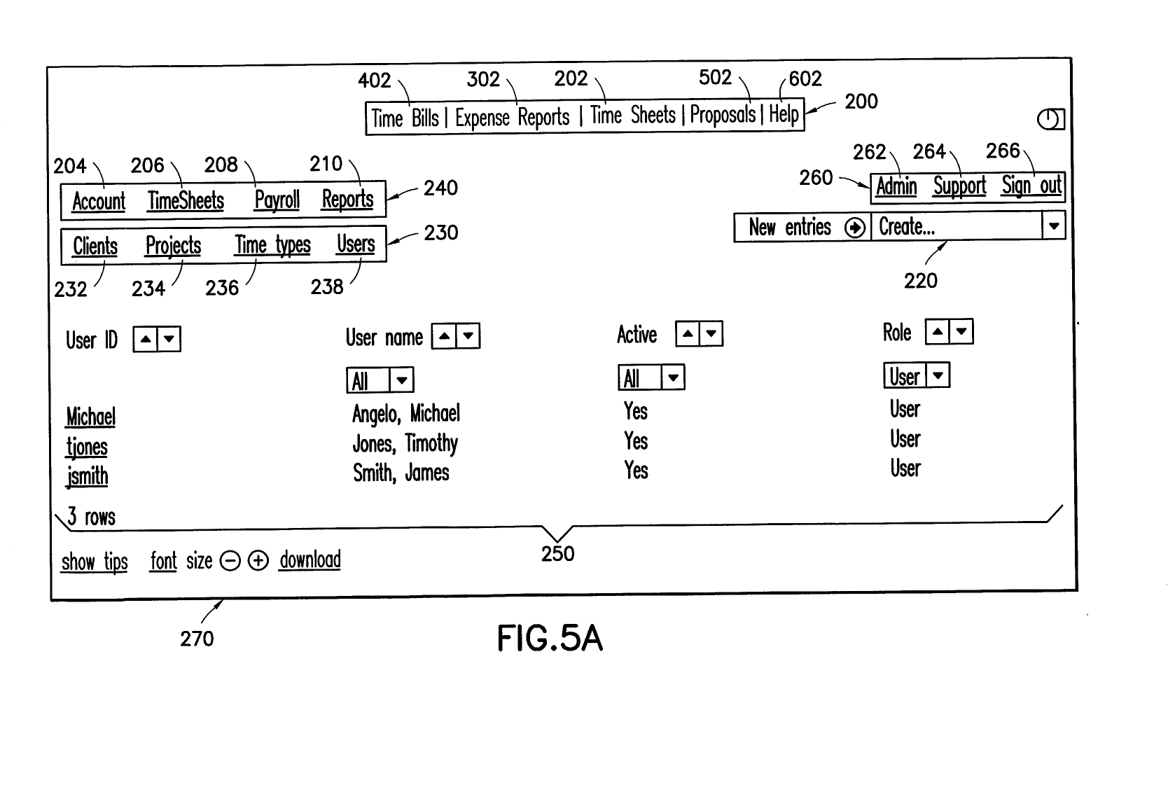

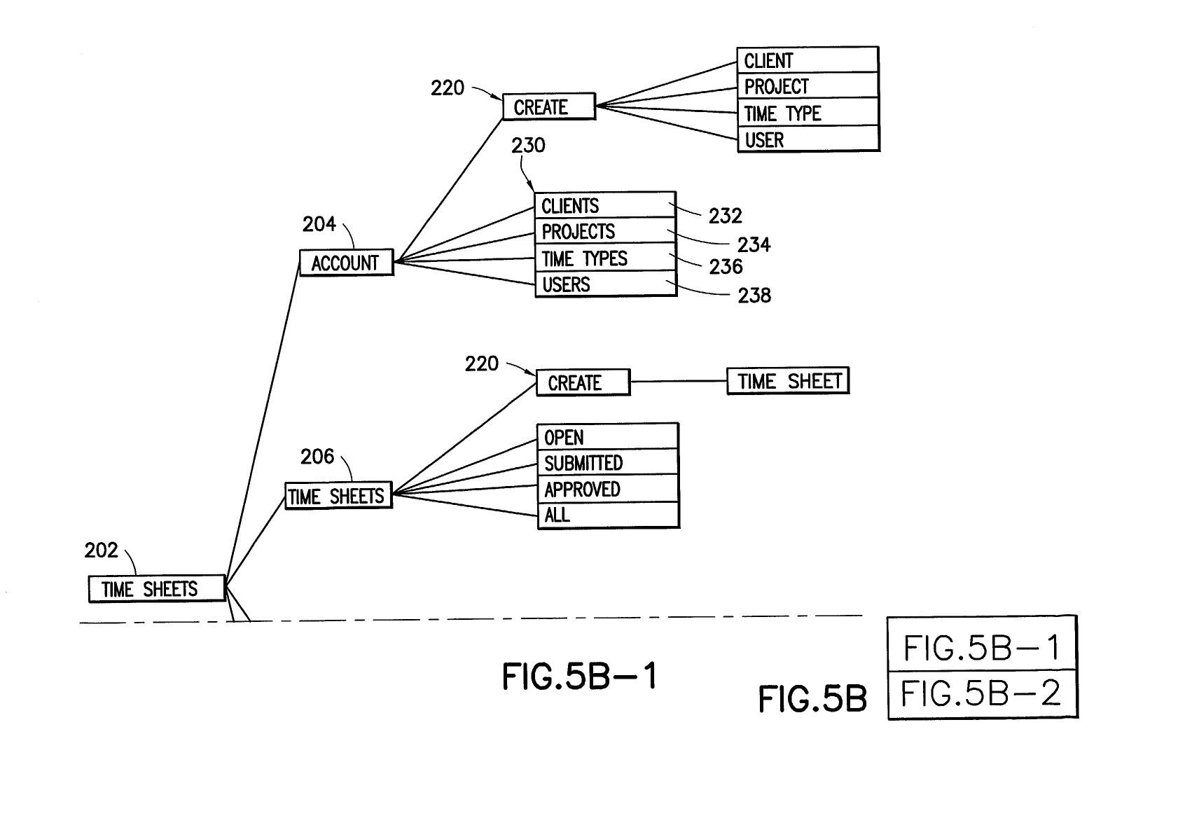

Referring next to FIGS. 5A and 5B, the time sheets functionality provided by the server 10 and special purpose software 60 in accordance with the present invention will now be discussed. The time sheets functionality enables a first user to enter hours worked and type of time worked (overtime, etc.), for example. The first user may then elect to associate the hours worked with a specific client, a specific project, and a specific service (that data having previously entered by a system administrator and as described in more detail below); those associations being entered by the first user using time sheets functionality. The first user may also record notes pertinent to the particular client, project, and/or service. The time sheets functionality of the special purpose software 60 also enables automatic submission of the time by the first user to a second user (often a manager or supervisor) for approval. The time sheets functionality of the special purpose software 60 automatically sends the second user an email with an embedded link that may be selected by the second user. In response to that action by the second user, an Internet browser window is opened on the second user's computer, a connection to the web site established, and the second user logs on to his/her account on the web site and is automatically shown the time sheets submitted by the first user. The second user reviews the time sheets and either approves or rejects the time sheets, and an appropriate email is automatically sent to the first user indicating the second user's approval or rejection. If the second user approves the time sheets, he/she may select certain time items in the time sheets for porting to time billing application program (described in more detail below).

For the time sheets web page 270 depicted in FIG. 5A, a user has selected the account link 204 (from the application navigation links 240) and users link 238 (from the data viewing and editing links 230), and the data 250 depicted in that figure represent that user's account data for all users. The diagrammatic view of FIG. 5B depicts all the selections available to a user via the time sheets web page 270 (e.g., user identification, user name, active status, and role). The account link 204 provided via the time sheets web page 270 enables a user to create, view, sort, or edit client, project, time type, or user data. The time sheets link 206 enables a user to create new time sheets or to view, sort, or edit open, submitted, approved, or all time sheet data for that user's account. The payroll link 208 enables a user to setup and maintain the payroll functionality for that user's account, including importing company and employee data from another computer (remote from the server 10). The reports link 210 enables a user to create a summary of activities related to that user's account, including reports on users, time types, clients, or projects. Detail reports may also be created for time entries, users, clients, or projects.

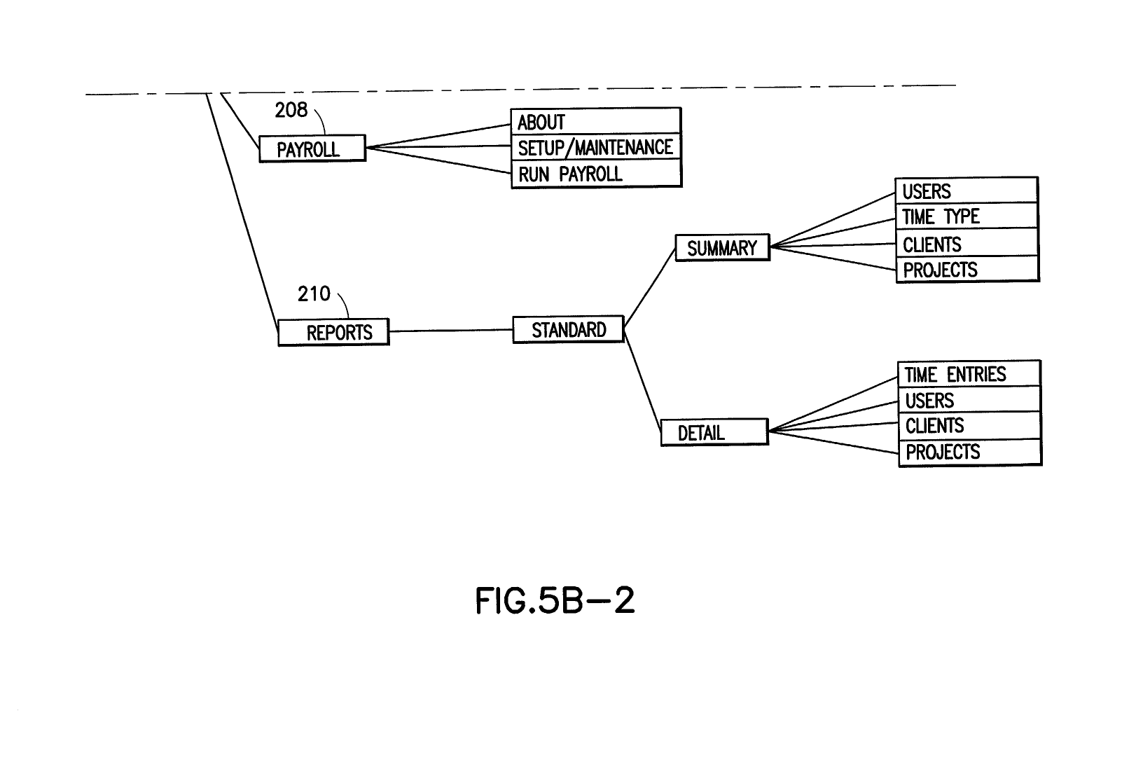

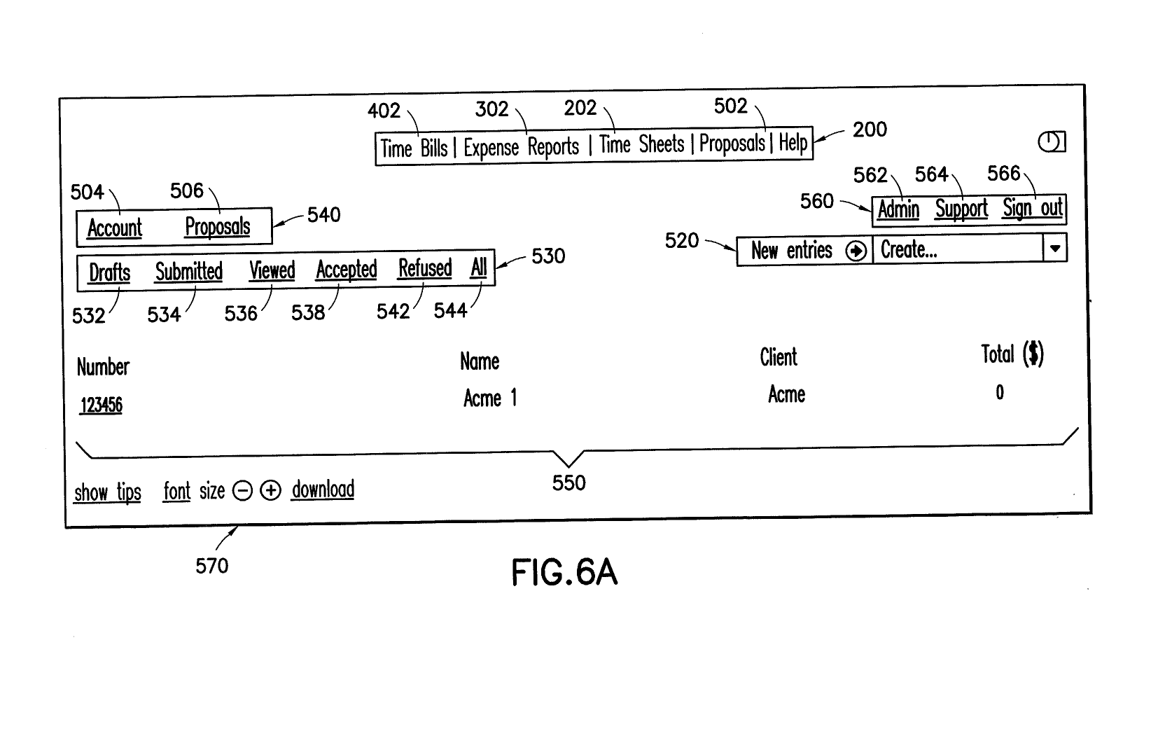

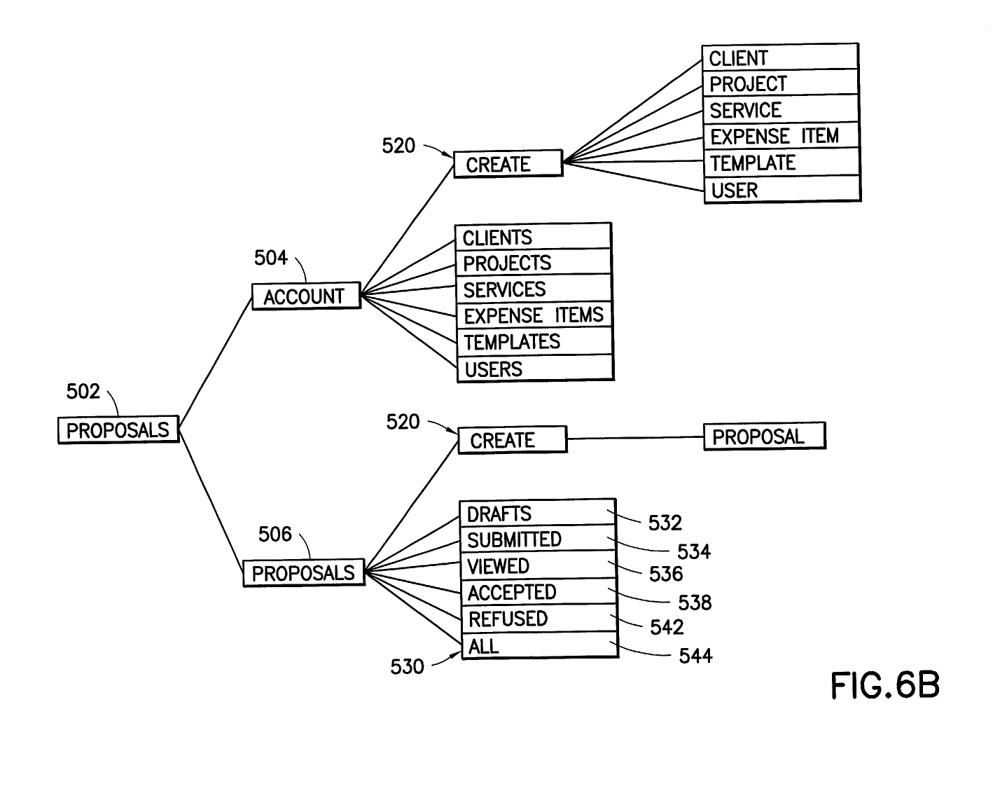

Referring next to FIGS. 6A and 6B, the proposals functionality provided by the server 10 and special purpose software 60 in accordance with the present invention will now be discussed. The proposals functionality enables a user to create proposals and cost estimates, including budget for flat fees, hourly fees, expenses and other costs, and to transmit proposals electronically and instantly track the status of each proposal via the web site.

For the proposals web page 570 depicted in FIG. 6A, a user has selected the proposals link 506 (from the application navigation links 540) and drafts link 532 (from the data viewing and editing links 530), and the data 550 depicted in that figure represent all draft proposals for that user's account (e.g., proposal number, proposal name, client name, and total dollars). The diagrammatic view of FIG. 6B depicts all the selections available to a user via the proposals web page 570. The account link 504 provided via the proposals web page 570 enables a user to create, view, sort, or edit client, project, service, expense items, template, or user data. The proposals link 506 enables a user to create new proposals, or to view, sort, or edit draft, submitted, viewed, accepted, refused, or all proposal data for that user's account.

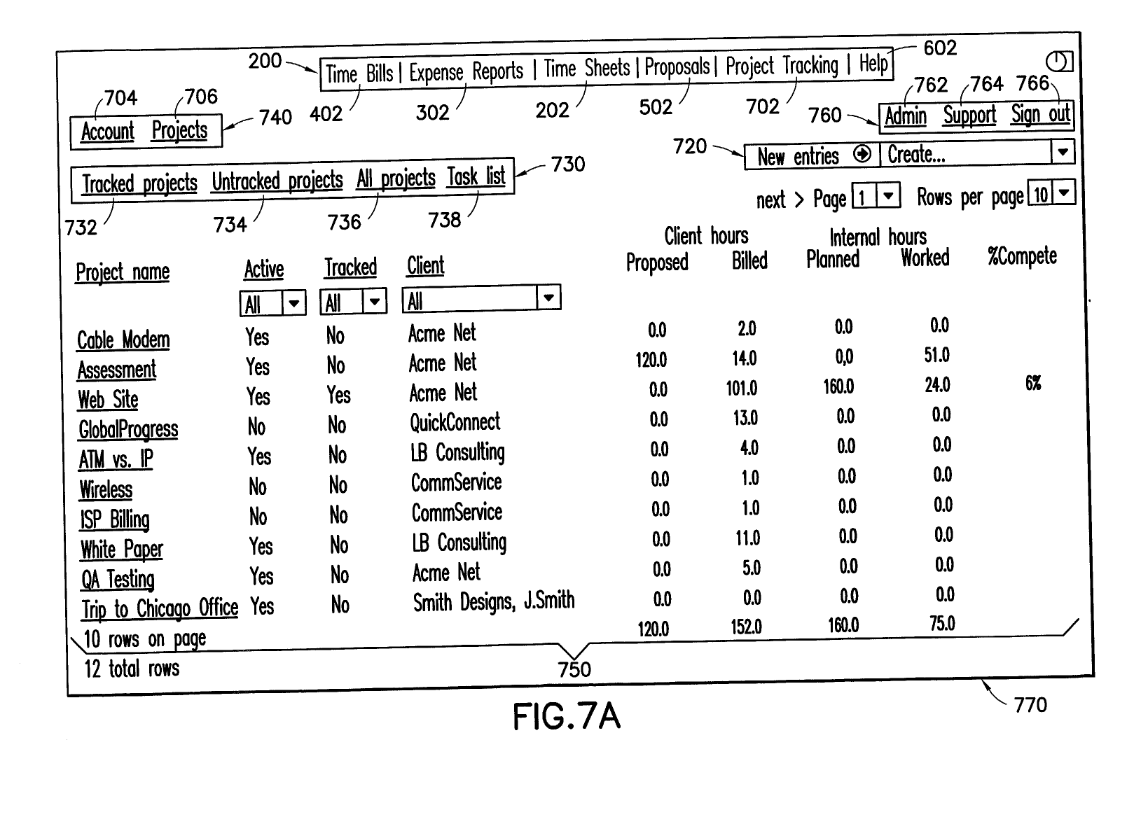

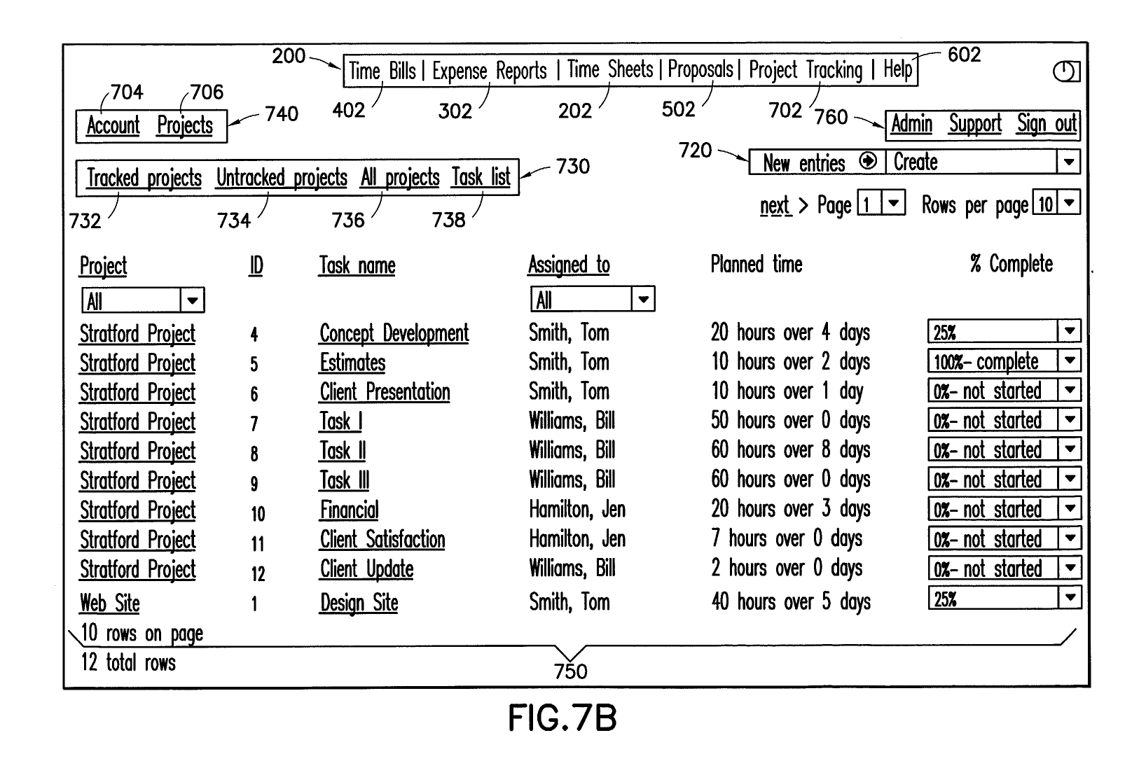

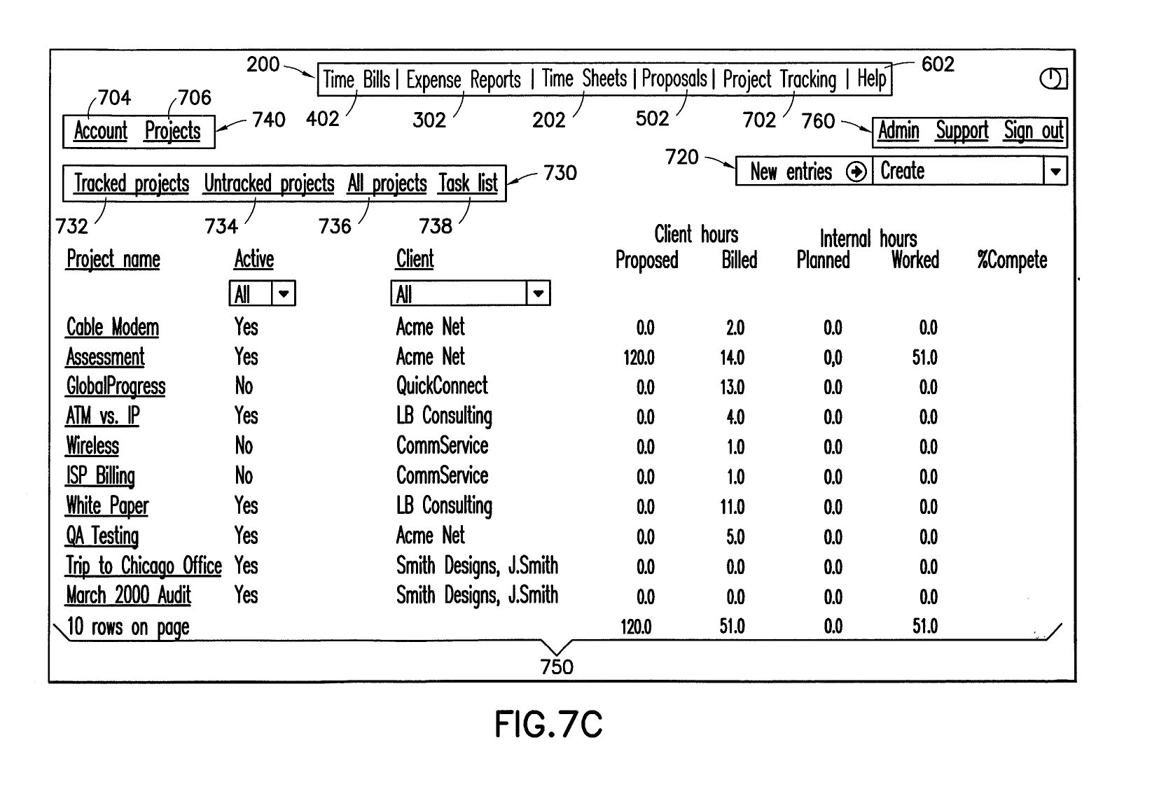

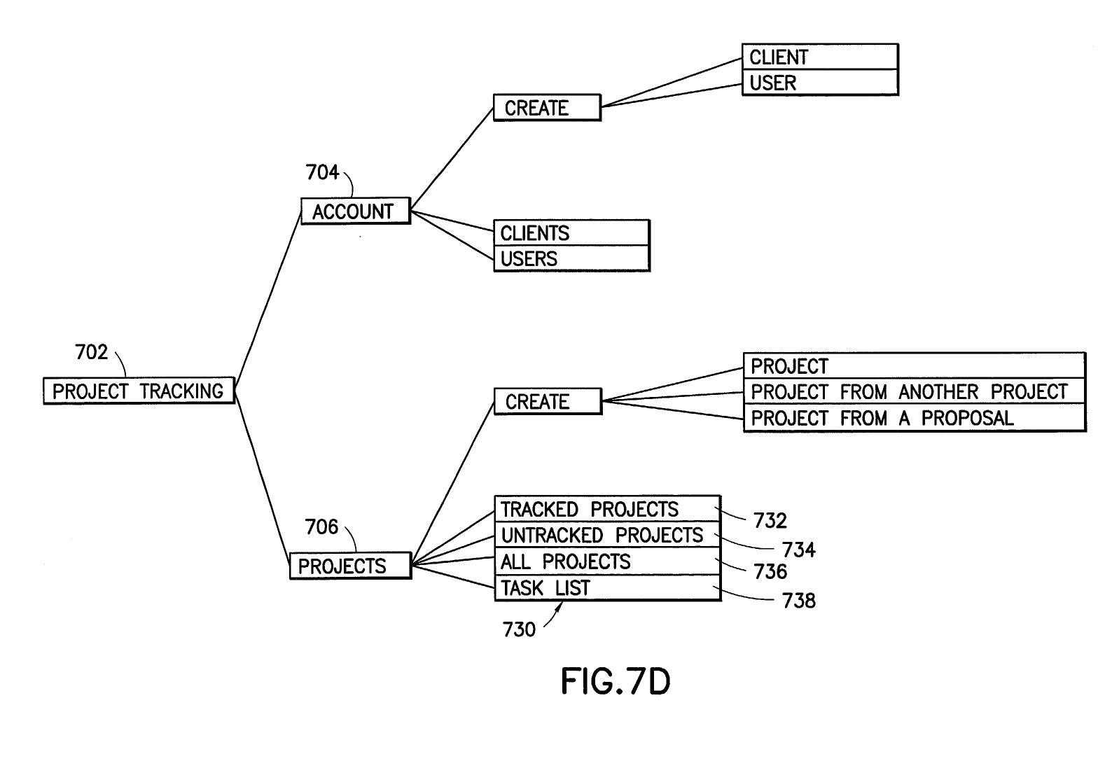

Referring next to FIGS. 7A and 7B, the project tracking functionality provided by the server 10 and special purpose software 60 in accordance with the present invention will now be discussed. The project tracking functionality enables a user to: instantly view a Gantt chart of actual time vs. planned time to identify and solve project issue; boost profits with more accurate project planning; plan and price current projects more accurately using historical views of project data; choose to run projects at a summary or detailed level; manage projects virtually to increase delivery performance (local and remote employees and project managers can see constantly updated information on project status from any computer with a browser and Internet connection; create phases and subphases under each project depending on the project complexity; make one phase's start dependent upon another phase's completion; determine task start/end dates and set task duration; create tasks, link them to particular phases, crate dependencies between tasks, determine start/end dates and duration; assign the task to a particular user (and communicate that assignment to that user (and possibly that user's supervisor); view, in real time, project phases, subphases, tasks, dependencies between items, start/end dates and percent of work completed and billed. As users complete work on tasks and log time in using the time sheets functionality, data is automatically updated by the project tracking functionality.

In an embodiment of the project tracking functionality of the present invention, administrators can create project plans and assign resources to tasks, power users can view all employee assigned tasks, and users can only see their own assigned tasks for particular projects.

For the project tracking web page 770 depicted in FIG. 7A, a user has selected the projects link 706 (from the application navigation links 740) and all projects link 736 (from the data viewing and editing links 730), and the data 750 depicted in that figure represent all projects for that user's account, identified by project name and indicating various other characteristics and data for each project (e.g., active status, tracked status, client name (for whom the project being carried out), client hours (external hours), internal hours, and percent complete).

For the project tracking web page 770 depicted in FIG. 7B, a user has selected the projects link 706 (from the application navigation links 740) and task list link 738 (from the data viewing and editing links 730), and the data 750 depicted in that figure represent all task list data for that user's account, identified by project name and indicating various other characteristics and data for each project (e.g., task name, person to whom the task is assigned, planned time for completion, and percent complete).

For the project tracking web page 770 depicted in FIG. 7C, a user has selected the projects link 706 (from the application navigation links 740) and untracked projects link 734 (from the data viewing and editing links 730), and the data 750 depicted in that figure represent all untracked project data for that user's account, identified by project name and indicating various other characteristics and data for each project (e.g., active status, client name, client hours (external hours), internal hours, and percent complete).

The diagrammatic view of FIG. 7B depicts all the selections available to a user via the project tracking web page 770. The account link 704 provided via the project tracking web page 770 enables a user to create, view, sort, or edit client and user data. The projects link 706 enables a user to create new projects (from scratch), create new projects from other projects, or create new projects from proposals. The projects link 706 also enables a user to view tracked projects, untracked projects, all projects, or task list data for that user's account.

Once a user has selected one of the available functionality (e.g., by clicking-on the desired option with a mouse or other cursor-control device), the web server 50 and application server 30 process the user's selection, invoke the necessary application programs of the special purpose software 60, and communicate the appropriate data (e.g., HTML, Javascript, account data, etc.) to the user's computer 80 for display thereon by the browser. Other functionality may be provided by the application server 30 and special purpose software 60 upon the user's selection of various navigational links, as described above.

The special purpose software 60 also includes an off-line application program 84 that may be downloaded from the application server 30 and used locally on user's computers 80. The program 84 enables a user to enter time and expenses data in time sheets and expense reports, and to create time bills while disconnected from the Internet and the web site. The next time a user connects to the Internet after the data has been entered locally on the user's computer 80, that data is transferred to the user's account on the web site (i.e., to the data server 40). Once the data is transferred from the user's computer 80, it is deleted therefrom by the special purpose software 60.

In order for the off-line application program 84 to work properly, a user's client, project, and other account data must be transferred from the data server 40 to the user's computer 80 for use by the program 84. The program 84 prompts the user to do this when the program 84 is executed. The user must enter company identification, user identification, and password data. The program 84 then automatically locates and copies the user's client, project, service, expense item, and other account information from the data server 40 onto the user's computer hard drive. New clients, projects, or other account information may not be created using the off-line application program 84.

The off-line version of time bills functionality is limited to entering data; users cannot send invoices via the off-line application program 84, which can only be accomplished after the data from the off-line program 84 has been uploaded to the web site (i.e., to the data server 40).

Data entered off-line via the time bills functionality may be transferred to the server 10 by opening (i.e., executing, invoking, etc.) the off-line program 84 with the newly entered data, connecting to the Internet, and electing to update. Before data is uploaded from the user's computer 80 to the data server 40, the web server 50 and application server 30 validate the user's identification and password data (as described above) to ensure security and transfer of the data to the user's account. Once data has been transferred to the data server 40, it is deleted from the user's computer 80 and exists only on the data server 40.

The off-line version of expense reports functionality enables users to enter expense data in a manner similar to that provided via the web site but, the functionality is limited to data entry. Envelopes may not be submitted for approval, nor may they be approved; those functionality only being provided via the web site and only after the off-line data has been uploaded to the data server 40.

The off-line version of time sheets functionality enables a user time data in a manner similar to that provided via the web site, but that functionality is limited to data entry. Data entered using the off-line time sheets functionality can only be submitted for approval, and approved via the web site.

The special purpose software 60 may be provided as a single application program or as a plurality of application programs, as a routine matter of design choice. Likewise, the programming language use to create the special purpose software 60 may be any suitable now known or hereafter developed programming language.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. An Internet based time and expense data system comprising:
a first server for interfacing with the Internet and having a data storage device having general purpose software stored thereon;
a second server in communication with said first server and having a data storage device, said second server also having general and special purpose software stored on said data storage device;
a third server having a data storage device for storing a plurality of data in a database and having general purpose software stored thereon, said third server being in communication with said second server; and
said special purpose software being operable in connection with a processor and the general purpose software provided on each of said first, second and third servers for:
receiving data from a user of said system via the Internet;
storing the received user data in said database as internal data; and
creating external data from the internal data based upon user-selected criteria for converting internal data to external data and storing the external data in said database.

2. A system as recited by claim 1, wherein said special purpose software comprises a plurality of application programs including a time bills, an expense reports, a time sheets, a proposal and a project tracking application program.

3. A system as recited by claim 1, wherein said special purpose software comprises an application program for providing time bills, expense reports, time sheets, proposal and project tracking functionality.

4. A system as recited by claim 3, wherein said special purpose software further comprises an off-line application program downloadable via the Internet to a computer remote from said first server, a user of the remote computer having an account having a plurality of data items defined and stored in said database, said off-line application program being installable on the remote computer and operable with a processor of the remote computer for:
storing time and expense data in a database on a data storage device of the remote computer;
establishing a connection from the remote computer to said first server via the Internet; and
communicating the stored time and expense data to said third server for storage in said database as internal data;
said special purpose software being further operable in connection with the processor of said second server for deleting the stored time and expense data from the data storage device of the remote computer after the stored time and expense data is communicated to said third server.

5. A system as recited by claim 4, wherein said special purpose software is further operable in connection with the processor of said second server to download the plurality of data items for the user's account to the remote computer when said off-line application program establishes a connection from the remote computer to said first server.

6. A system as recited by claim 1, wherein said special purpose software is further operable in connection with the processor of said second server to create an invoice for a client from the external data and for communicating said invoice to the client over the Internet via said first server.

7. A system as recited by claim 1, wherein said first server, said second server, and said third server comprise a single computer.

8. A system as recited by claim 1, wherein said first server, said second server, and said third server comprise separate interconnected computers.

9. A system as recited by claim 1, wherein said third server comprises a plurality of interconnected computers and wherein said database comprises a plurality of databases provided on said plurality of interconnected computers.

11. A system as recited by claim 1, wherein said data storage device of said third server comprises a high speed data storage device.

12. An Internet based time and expense data system comprising:
a server having a data storage device and having general and special purpose software stored thereon, said data storage device including a plurality of data stored in a database and said server being connected to the Internet, said special purpose software being operable in connection with a processor of said server and the general purpose software for:
receiving data from a user of said system via the Internet;
storing the received user data in said database as internal data; and
creating external data from the internal data based upon user-selected criteria for converting the internal data to external data and storing the external data in said database.

13. A system as recited by claim 12, wherein said special purpose software comprises a plurality of application programs including a time bills, an expense reports, a time sheets, a proposal, and a project tracking application program.

14. A system as recited by claim 12, wherein said special purpose software comprises an application program for providing time bills, expense reports, time sheets, proposal, and project tracking functionality.

15. A system as recited by claim 14, wherein said special purpose software further comprises an off-line application program downloadable via the Internet to a computer remote from said server, a user of the remote computer having an account having a plurality of data items defined and stored in said database, said off-line application program being installable on the remote computer and operable with a processor of the remote computer for:
storing time and expense data in a database on a data storage device of the remote computer;
establishing a connection from the remote computer to said server via the Internet; and
communicating the stored time and expense data to said server for storage in said database as internal data;
said special purpose software being further operable in connection with the processor of said server for deleting the stored time and expense data from the data storage device of the remote computer after the stored time and expense data is communicated to said server.

16. A system as recited by claim 15, wherein said special purpose software is further operable in connection with the processor of said server to download the plurality of data items for the user's account to the remote computer when said off-line application program establishes a connection from the remote computer to the server.

17. A system as recited by claim 12, wherein said special purpose software is further operable in connection with the processor of said server to create an invoice for a client from the external data and for communicating said invoice to the client over the Internet via said server.

18. A system as recited by claim 12, wherein said server comprises a single computer.

19. A system as recited by claim 12, wherein said server comprises a plurality of separate interconnected computers.

20. A system as recited by claim 12, wherein said database comprises a plurality of databases provided on said plurality of interconnected computers.

21. A system as recited by claim 21, wherein said data storage device of said server comprises a high speed data storage device.
